(19) United States
(12) Patent Application Publication
(10) Pub. No.: US 2016/0243487 A1
(43) Pub. Date: Aug. 25, 2016

(54) A FLUSHING PRECIPITATOR

(71) Applicant: C CUBE CO., LTD., Gwacheon-si, Gyeonggi-do (KR)

(72) Inventor: Hyung Don KIM, Gwacheon-si (KR)

(73) Assignee: C CUBE CO., LTD., Gwacheon-si, Gyeonggi-do (KR)

(21) Appl. No.: 14/380,772

(22) PCT Filed: Apr. 21, 2014
(86) PCT No.: PCT/KR2014/003472

§ 371 Date: Aug. 25, 2014

(30) Foreign Application Priority Data
May 3, 2013 (KR) 10-2013-0050007

(51) Int. Cl. B01D 47/06; A23F 5/04

(52) U.S. Cl. CPC B01D 47/06; A23F 5/04

(57) ABSTRACT

A dust collector separates dust from the gas including the dust such as smoke discharged from a coffee roasting machine. The dust collector uses a water spray. The dust collector can prevent blockage of nozzles of a upper water supply line and a side water supply line by arranging the upper nozzle and the side nozzle, which spray water, to be faced to each other within the body of the dust collector. Water flows along the side within the inlet which is slant downward, which allows the gas to flow into the body of the dust collector, and a separate assistant water supply line is connected to the inlet.

### TECHNICAL FIELD

The present invention relates to a dust collector which separates dust from the gas including dust such as smoke discharged from a coffee roasting machine, by using a water spray, and more particularly, to a dust collector which can efficiently collect dust even at the corner of the body and prevent the nozzles of the upper water supply line and the side water supply line from being clogged by spraying water upward and downward so that the upper nozzle and the side nozzle, which spray water, to be faced to each other within the body of the dust collector, can prevent the back flow of water through an inlet or dust from being stuck within the inlet by letting water flow along the side within the inlet which is slant downward as the inlet, which allows the gas to flow into the body of the dust collector, is connected to the body in a manner that is slant downward, and a separate assistant water supply line is connected to the inlet, can enhance the collection efficiency and prevent dust from being stuck within an exhaust portion by forming a separate exhaust nozzle within the exhaust portion and spraying water again to the gas which is finally discharged through the exhaust portion, and can reuse water including dust collected discharged from the dust collector after removing dust through the water reprocessing unit.

### BACKGROUND ART

The gas, which is combusted and discharged from a coffee roasting machine, contains dust, and when the gas including the dust is discharged to the air, it negatively affects the environment, and thus a dust collector for removing dust from the gas which is combusted and discharged has been used.

The following patent document relates to a dust collector according to a conventional art.

### PATENT LITERATURE

Korean Patent No. 10-0312816 (published on 3 Nov. 2001) “Turbo Rotary Scrubber”

Likewise, the convention dust collector usually uses the principle of removing dust as dust is stuck on water as the gas containing dust passes through water.

However, the conventional dust collectors may generate large noise or cannot clean minute dust. Further, maintenance may be difficult and durability may be low in the conventional dust collectors.

Hence, the present invention is suggested to present a solution to a dust collector of a new structure which solves the problems of the conventional dust collectors and is specialized in removing dust (e.g., silverskin powder of coffee beans) contained the gas discharged from the coffee roasting machine

### DISCLOSURE

### Technical Problem

The present invention has been prepared to solve the above problems.

An object of the present invention is to provide a dust collector which separates dust from the gas including dust such as smoke discharged from a coffee roasting machine, by using a water spray, and more particularly, a dust collector which can efficiently collect dust even at the corner of the body and prevent the nozzles of the upper water supply line and the side water supply line from being clogged by spraying water upward and downward so that the upper nozzle and the side nozzle, which spray water, to be faced to each other within the body of the dust collector.

Another object of the present invention is to provide a dust collector which can prevent the back flow of water through an inlet or dust from being stuck within the inlet by letting water flow along the side within the inlet which is slant downward as the inlet, which allows the gas to flow into the body of the dust collector, is connected to the body in a manner that is slant downward.

Another object of the present invention is to provide a dust collector which can prevent the back flow of water through an inlet or dust from being stuck within the inlet by letting water flow along the side within the inlet which is slant downward as the inlet as a separate assistant water supply line is connected to the inlet.

Another object of the present invention is to provide a dust collector which can enhance the collection efficiency and prevent dust from being stuck within an exhaust portion by forming a separate exhaust nozzle within the exhaust portion and spraying water again to the gas which is finally discharged through the exhaust portion.

Another object of the present invention is to provide a dust collector which can reuse water including dust collected discharged from the dust collector after removing dust through the water reprocessing unit.

### Technical Solution

The dust collector for achieving the above objects is configured as follows.

A dust collector according to an embodiment of the present invention includes an inlet into which a gas containing dust flows; a spray unit which sprays water to the gas, within a body, which has been flown through the inlet; a water drain part through which water containing dust collected in the water spray through the spray unit is drained; and a gas discharge part through which the gas, from which the dust has been removed, is discharged.

The spray unit may include an upper water supply line which supplies water to an upper part of the body and a side water supply line which supplies water to a side of the body, a nozzle at an end part of the upper water supply line sprays water upward from the side of the body so as to efficiently perform dust collection even at the corner of the body and prevent the nozzles of the upper water supply line and the side water supply line from being clogged.

The inlet may be connected to a body which is slant downward and may prevent water from being flown backward through the inlet.

The spray unit may connect a separate assistant water supply line to the inlet so as to let water flow along an inner surface of the inlet which is slant downward.

The spray unit may form a separate gas discharge nozzle within the gas discharge part, enhance dust collection efficiency by spraying water again to a gas which is finally discharged through the gas discharge part within the gas discharge part, and prevent dust from being stuck in the gas discharge part.

The gas discharge nozzle may spray water at an angle which is slant downward at an inner surface of the gas discharge part, and enhance dust collection efficiency and washing efficiency of the inner surface of the gas discharge part.

The dust collector may further include a water tank which temporarily stores water containing collected dust which is drained from the water drain part; and a water reprocessing unit which reuses water which is supplied through the spray unit by diverting water higher than a certain water level in the water tank.

The water reprocessing unit includes a centrifugal filter net which removes dust contained in water by centrifuging water which is flown in after being diverted in the water tank, and a storage tank which stores water, from which dust has been removed through the centrifugal filter net, and the centrifugal filter net is coupled with the storage tank in a detachable manner so that separate washing may be possible.

### Advantageous Effects

The following effects can be obtained from the present invention.

According to the present invention, dust can be efficiently collected even at the corner of the body and the nozzles of the upper water supply line and the side water supply line can be prevented from being clogged by spraying water upward and downward so that the upper nozzle and the side nozzle, which spray water, to be faced to each other within the body of the dust collector.

According to the present invention, the back flow of water through an inlet or dust can be prevented from being stuck within the inlet by letting water flow along the side within the inlet which is slant downward as the inlet, which allows the gas to flow into the body of the dust collector, is connected to the body in a manner that is slant downward.

According to the present invention, the back flow of water through an inlet or dust can be prevented from being stuck within the inlet by letting water flow along the side within the inlet which is slant downward as the inlet as a separate assistant water supply line is connected to the inlet.

According to the present invention, the collection efficiency can be enhanced and dust can be prevented from being stuck within an exhaust portion by forming a separate exhaust nozzle within the exhaust portion and spraying water again to the gas which is finally discharged through the exhaust portion.

According to the present invention, water including dust collected discharged from the dust collector can be reused after removing dust through the water reprocessing unit.

### DESCRIPTION OF DRAWINGS

FIG. 1 illustrates a dust collector according to an embodiment of the present invention.

FIG. 2 illustrates an example where water is sprayed at nozzles of an upper water supply line and a side water supply line of FIG. 1.

FIG. 3 illustrates an example where water is flown within an inlet through an assistant water supply line of FIG. 1.

FIG. 4 is A-A′ cross-sectional view of FIG. 1.

FIG. 5 illustrates an example where water is sprayed from a gas discharge nozzle.

FIG. 6 illustrates a process where water containing dust is reprocessed through a water reprocessing unit of FIG. 1.

FIG. 7 illustrates an example where a centrifugal filter net is coupled with a storage tank in a detachable manner.

### DETAILED DESCRIPTION OF EXEMPLARY EMBODIMENTS

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art.

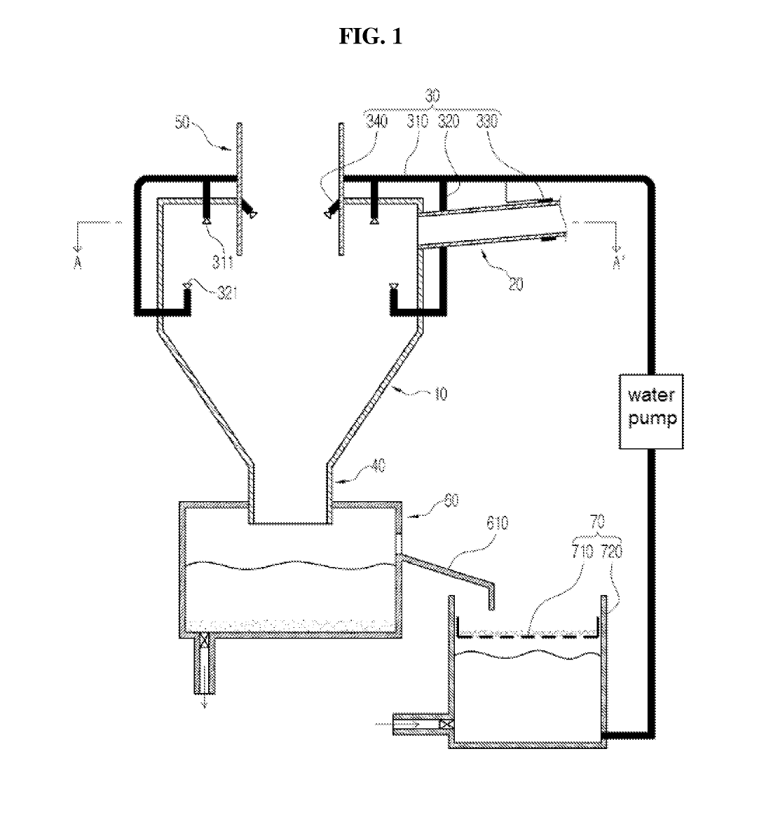

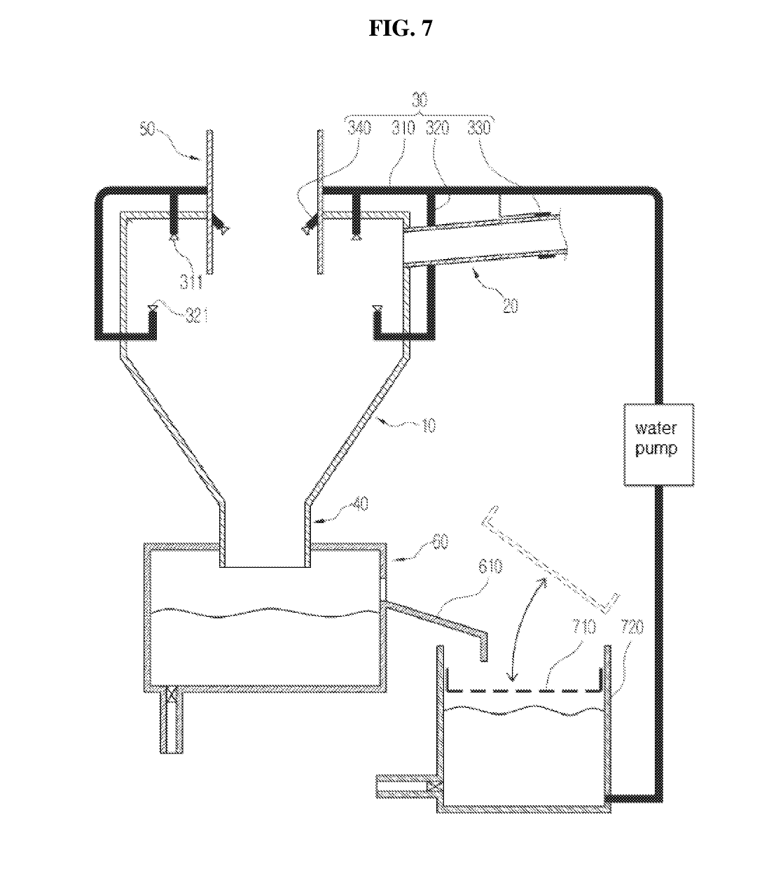

Referring to FIGS. 1 to 7, a dust collector according to an embodiment of the present invention includes an inlet into which a gas containing dust flows, a spray unit 30 which sprays water toward the gas within a body 10 which has been flown through the inlet 20, a water drain part 40 through which water containing dust collected in the water which has been sprayed through the spray unit, and a gas discharge part 50.

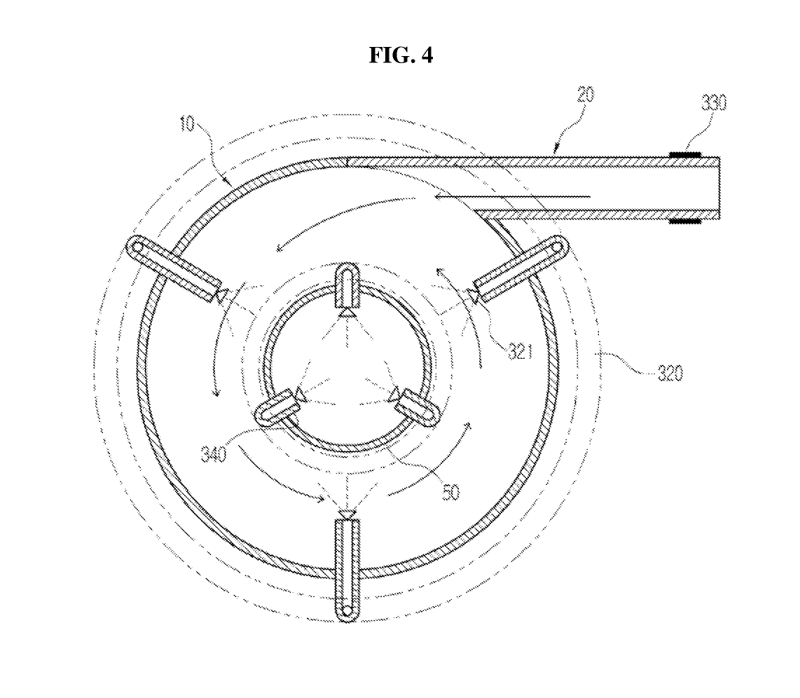

The inlet 20 is a passage through which the combusted gas discharged from the coffee roasting machine flows into the body 10 of the dust collector. The gas, which has been flown into the inlet 20 remains in the body 10 of the dust collector. At this time, the inlet 20 may be connected to the edge direction of one side of the body 10 as illustrated in FIG. 4, in order to form a warm flow like a cyclone within the body 10 by the flow speed of the gas which is flown through the inlet. That is, rather than the gas's having a regular flow or being stuck within the body, having an irregular warm flow enhances the efficiency of collecting dust (e.g., silver skin powder of coffee beans) in the sprayed water. To this end, the inlet 20 may be connected to the edge direction of one side of the body 10.

The body is a space where the body of dust collector is formed. The body is a space where the gas, which has been flown in through the inlet, remains and contacts the water sprayed through the spray unit 30 so that the dust contained in the gas is collected.

The spray unit 30 sprays water within the body 10 so that the sprayed water may collect dust contained in the gas. The spray unit a nozzle and a water supply line for spraying water toward the body 10, which will be described in detail later.

The water drain part 40 is formed at the bottom of the body 10 so that the water containing the dust collected in the water sprayed through the spray unit 30 is drained to the outside of the body 10.

The gas discharge part 50 becomes the passage through which the gas, from which the dust has been removed by the water sprayed through the spray unit 30 within the body 10, is discharged.

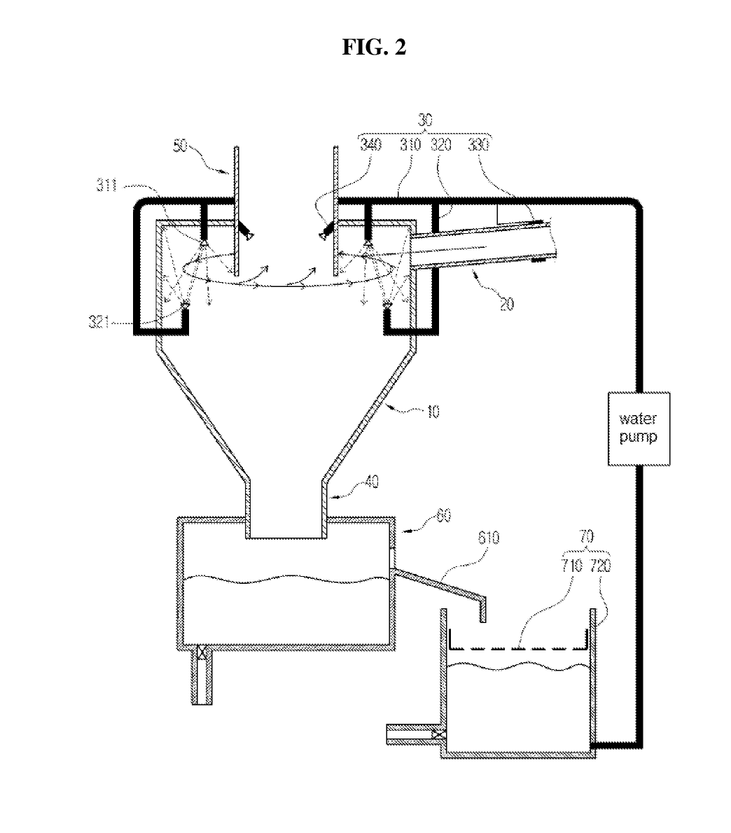

In particular, the dust collector of the present invention includes an upper water supply line 310 which supplies water to the upper part of the body and a side water supply line 320 which supplies water to the side of the body 10 as illustrated in FIG. 1. Furthermore, as illustrated in FIG. 2, the nozzle 311 at the end part of the upper water supply line 310 sprays water downward from the upper part of the body, and the nozzle 321 at the end part of the side water supply line 320 sprays water upward from the side of the body 10 so that the dust collection is efficiently performed even at the corner of the body 10 and the nozzles 311 and 321 of the upper water supply line 310 and the side water supply line 320 can be prevented from being stuck.

In detail, the spray unit 30 is divided into 2 lines and allows water to be sprayed in 2 directions within the body 10. First, in the upper water supply line 310 which supplies water to the upper part of the body 10, a plurality of nozzles are inserted and installed in the body 10 at the upper part of the body 10 so that the water supplied through the upper water supply line 310 is sprayed downward from the upper part of the body 10 through the nozzles 311 as illustrated in FIG. 2, and in the side water supply line which supplies water to the side of the body 10, a plurality of nozzles 321 are inserted and installed in the body at the side of the body 10 so that the water supplied through the side water supply line 320 is sprayed upward from the side of the body 10 through the nozzles as illustrated in FIG. 2. Likewise, the spray unit 30 sprays water in two directions in order to effectively collect dust by increasing the contact with the dust contained the gas within the body as the water sprayed downward and the water sprayed upward is mixed. Further, in the case of the water which is sprayed upward within the body 10, the water is set to be sprayed to every corner of the body including the upper edge of the body 10 so as to prevent dust from being stuck on the body 10.

Furthermore, minute holes of the nozzles 311 and 321 can be easily clogged when dust is accumulated, and thus frequent repair may be required. In the present invention, the water, which is sprayed downward from the nozzle 311 of the end part of the upper water supply line 320, washes the dust of the nozzle 321 of the side water supply line 320, and the water, which is sprayed upward from the nozzle 321 of the end part of the side water supply line 320, may wash the dust of the nozzle 311 of the upper water supply line 310, and thus the maintenance efficiency may be enhanced by preventing the nozzles 311 and 321 from being clogged by the dust.

Furthermore, the inlet 20 is connected to the body in manner that is slant downward so as to prevent the water sprayed within the body 10 from being flown backward through the inlet 20. That is, in the present invention, water is sprayed within the body 10 in order to collect and remove dust contained in the gas, and thus the water drops or moisture sprayed within the body 10 may flow backward through the inlet. Hence, in order to prevent such a back flow, the inlet 20 is connected to the body 10 in a manner that is slant downward as illustrated in FIG. 1, and thus the water drops or moisture sprayed within the body 10 cannot flow backward in the body 10.

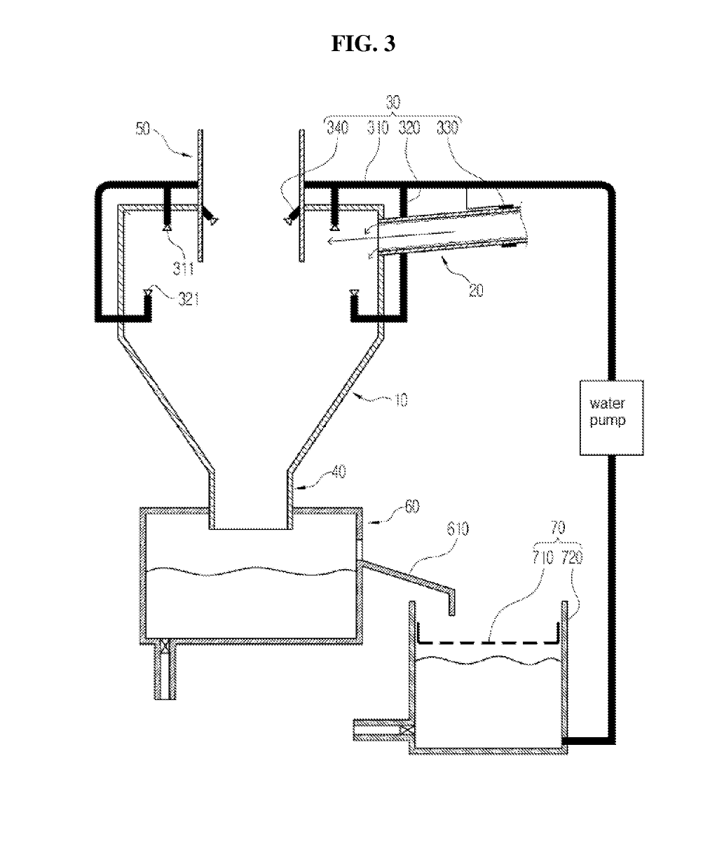

At this time, the spray unit 30 may additionally connect a separate assistant water supply line 330 to the pipeline within the inlet 20 so that the water may flow down along the inner surface of the inlet 20 which is slant downward. That is, even in the pipeline of the inlet 20, through which the gas containing dust passes, the diameter of the pipeline may become narrow due to the accumulation of the dust. Hence, in order to prevent this, a separate assistant water supply line 330 is connected to the pipeline of the inlet 20 so as to prevent the accumulation of the dust within the pipeline of the inlet 20. At this time, water is not sprayed within the pipeline of the inlet 20, but the water is supplied in a scheme that flows water along the pipeline of the inlet 20 which is slant downward as illustrated in FIG. 3, in order to prevent the backflow of water drops or moisture within the inlet 20.

Furthermore, the spray unit 30 forms a separate gas discharge nozzle 340 within the gas discharge part 50 and sprays water again to the gas which is finally discharged through the gas discharge part 50 in order to enhance the dust collection efficiency and prevent the dust from being stuck on the gas discharge part 50. That is, after the dust contained in the gas is collected and removed by the water which is sprayed through the nozzles 311 of the upper water supply line 310 and the nozzles 321 of the side water supply lines 320, a little dust may be still contained. Hence, if the dust may be accumulated on the pipeline of the gas discharge part 50 or the pipeline may become narrow. Hence, the dust collection efficiency is enhanced and the dust can be prevented from being stuck within the gas discharge part 50 by removing even a little remaining dust by spraying water again to the gas which is finally discharged through the gas discharge nozzle 340.

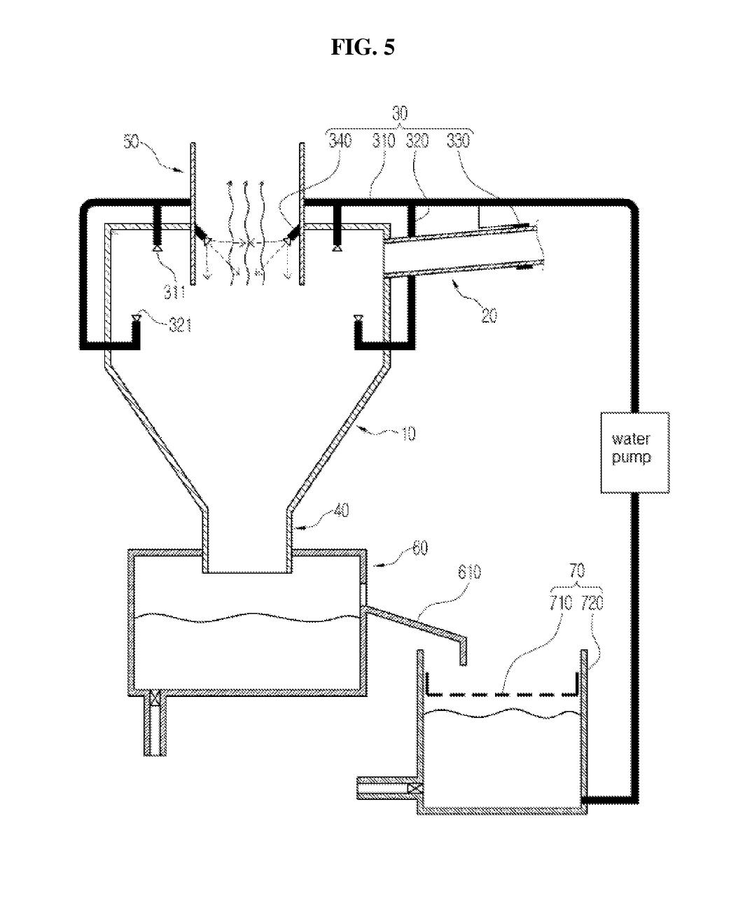

Furthermore, the gas discharge nozzle 340 sprays water in an angle which is slant downward from the inner surface of the gas discharge part 50 as illustrated in FIG. 5. This is to enhance the dust collection efficiency and the washing efficiency at the inner side of the gas discharge part 50 by spraying water for collecting dust in a manner that is slant downward, in response to the fact that the flow of the gas discharged through the gas discharge part 50 formed on the upper part of the body 10 is upward.

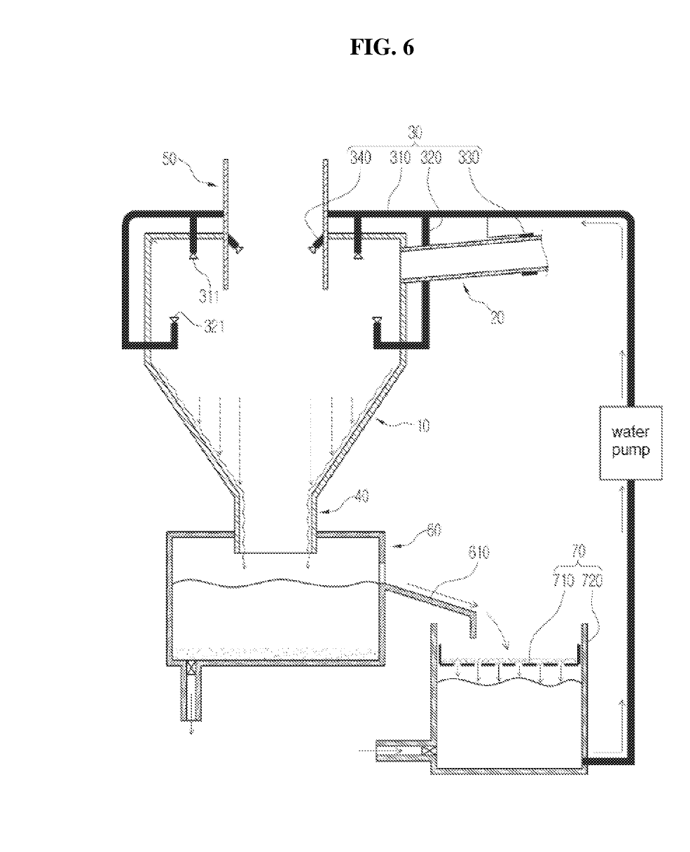

Furthermore, the dust collector according to the present invention may further include a water tank 60 for temporarily storing water containing dust which is discharged from the gas discharge part 40, and a water reprocessing unit 70 which reuses water higher than a certain water level in the water tank, as water which is supplied through the spray unit 30. The dust collection method of the present invention uses water, and if new water is always used, water resources are wasted and the costs will also be high. Hence, the present invention uses a water reprocessing unit which allows water to be reused. To this end, water containing dust is temporarily stored in the water tank 60 so that the dust may be deposited within the water tank 60. In this state, the water higher than a certain water level is moved to the water reprocessing unit 70 through a leading pathway 610 as illustrated in FIG. 6.

While the present invention has been particularly shown and described with reference to exemplary embodiments thereof, it will be understood by those of ordinary skill in the art that various changes in form and details may be made therein without departing from the spirit and scope of the present invention as defined by the following claims.

# Description of reference numerals

| | |
|---|---|
| 10: body; | 301: inlet |
| 30: spray unit | 310: upper water supply line |
| 311: nozzle | 320: side water supply line |
| 321: nozzle | 330: assistant water supply line |
| 340: gas discharge nozzle | 40: water drain part |
| 50: gas discharge part | 60: water tank |
| 610: leading pathway | 70: water reprocessing unit |
| 710: centrifugal filter net | 720: storage tank |

1.-8. (canceled)

9. A dust collector comprising:
an inlet into which a gas containing dust flows;
a spray unit which sprays water to the gas, within a body, which has been flown through the inlet;
a water drain part through which water containing dust collected in the water spray through the spray unit is drained; and
a gas discharge part through which the gas, from which the dust has been removed, is discharged,
wherein the spray unit includes an upper water supply line which supplies water to an upper part of the body and a side water supply line which supplies water to a side of the body, a nozzle at an end part of the upper water supply line sprays water upward from the side of the body so as to efficiently perform dust collection even at the corner of the body and prevent the nozzles of the upper water supply line and the side water supply line from being clogged.

10. The dust collector of claim 9, wherein the inlet is connected to a body which is slant downward and prevents water from being flown backward through the inlet.

11. The dust collector of claim 10, wherein the spray unit connects a separate assistant water supply line to the inlet so as to let water flow along an inner surface of the inlet which is slant downward.

12. The dust collector of claim 9, wherein the spray unit forms a separate gas discharge nozzle within the gas discharge part, enhances dust collection efficiency by spraying water again to a gas which is finally discharged through the gas discharge part within the gas discharge part, and prevents dust from being stuck in the gas discharge part.

13. The dust collector of claim 12, wherein the gas discharge nozzle sprays water at an angle which is slant downward at an inner surface of the gas discharge part, and enhances dust collection efficiency and washing efficiency of the inner surface of the gas discharge part.

14. The dust collector of claim 9, further comprising:
a water tank which temporarily stores water containing collected dust which is drained from the water drain part; and
a water reprocessing unit which reuses water which is supplied through the spray unit by diverting water higher than a certain water level in the water tank.
